(19) United States
(12) Patent Application Publication
(10) Pub. No.: US 2009/0277579 A1
(43) Pub. Date: Nov. 12, 2009

(54) Joining of Concentric Section Polymer Composite Components

(75) Inventors: Michael Andrew Marelli, Crows Nest (AU); Andrew Beehag, Glebe (AU); Rowan Paton, Brighton (AU)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: CRC FOR ADVANCED COMPOSITE STRUCTURES LIMITED, Fishermens Bend, Victoria (AU)

(21) Appl. No.: 12/440,350

(22) PCT Filed: Sep. 4, 2007
(86) PCT No.: PCT/AU07/01296

§ 371 Date: Mar. 6, 2009

(30) Foreign Application Priority Data
Sep. 8, 2006 (AU) 2006904966

(51) Int. Cl. B32B 37/06

(52) U.S. Cl. 156/293

(57) ABSTRACT

A process for assembling a composite component with a thermoplastic surface into or around a second component, the process including selecting a first component with a thermoplastic surface and a second component that, when assembled with the first component has at least some points of contact, shaping where necessary at least one component in the joint area, and pressing the components together to achieve relative immobility between the components. A second process involves the selection of a third thermoplastic component to be assembled with the first two components with at least some points of contact with the first and second components are achieved, shaping where necessary, and assembling such that relative immobility is achieved between all three components. In both processes, the joint area is then heated to allow the thermoplastic to flow and preferably weld the assembled components together.

### FIELD OF THE INVENTION

The present invention relates to the joining of a polymer composite component with another component. In particular, the invention relates to a polymer composite component with a mouldable thermoplastic surface which allows it to be inserted into or around a second component, leading to a tightly fitted joint. The components should have concentric sections, for at least the proportion of the components to be joined. Optionally the components may be welded together during or subsequent to the insertion operation.

### BACKGROUND OF THE INVENTION

Composite materials are a class of material which consist of at least two constituent materials, intimately joined together, which together behave as one material, usually with superior properties to either of constituent materials. Fibre reinforced polymer components, otherwise known as polymer composite components, consist of reinforcing fibres held together with a polymer resin, often known as the matrix. The polymer resin can be a thermosetting polymer such as epoxide (often called epoxy), bismaleimide or vinyl ester polymers, in which case the composite component can be called a thermoset composite component. Alternatively the polymer resin can be a thermoplastic polymer such as polypropylene (PP), polyethylene terephthalate (PET) or polyether ether ketone (PEEK), in which case the composite component can be called a thermoplastic composite component.

Thermosetting polymers usually consist of (as a minimum) a resin (monomer) and a hardener, which react together to produce a cross-linked polymer. Curing may be designed to occur at room temperature or higher temperature. Prior to curing, the monomer and hardener are normally in a liquid form, although their viscosities may be very high. During curing the monomer and hardener irreversibly react and the viscosity of the mixture increases until it becomes a solid cross-linked polymer. Thermosetting polymers are characterised by a glass transition temperature above which, with further heating, the material softens considerably and behaves like rubber. Further heating typically will cause the material to decompose, but melting of the polymer does not occur. By contrast, thermoplastics can be melted and resolidified by raising and lowering temperature. This characteristic of thermoplastic polymers has been utilised for the reshaping of thermoplastic material. It has also been utilised for the welding of thermoplastic and thermoplastic composite components.

Simple joining methods similar to those developed for metallic materials are often unavailable for polymer composites. This is particularly apparent in the joining of tubes. Metal tubes can be joined by inserting one tube into the other to give a tight interference fit, followed by the welding or brazing of the joint. Thermosetting composites have poor local plasticity at the surface, and tend to fracture at the surface when similarly pressed together, reducing properties of the thermosetting composite component and likely making the joint ineffectual. Additionally, to create a strong joint, an adhesive also has to be introduced into the joint area, a difficult task. Thermoplastic composites may have some surface plasticity during a similar tube insertion fitting operation if sufficient unfilled thermoplastic is present on at least one mating surface. However, any subsequent welding operation is likely to melt at least small portions of the thermoplastic composite, causing a loss in dimensional stability. This can result in distortion of the structure, introduction of voids and other problems likely to reduce the performance of the thermoplastic composite component.

The lack of quick, simple-to-apply joining methods has resulted in the extensive use of mechanical fastening, or the use of liquid and film adhesives, to join composite tubes and similar structures. Mechanical fasteners are not ideally suited to composites materials, which as a class of materials inherently have low bearing strength. Additionally mechanical fasteners, while they can be quick to install, reduce the local strength of the composite by introducing a hole. The use of adhesives is better suited to composites. However, adhesive application can be messy, particularly for insertion of close-fitting components. Adhesive application can also require use of personal protective equipment, and where low viscosity adhesives are used to enter close-fitting joints, a means of controlling overflow is required, and possibly cleaning of excess from the joint area after cure. Additionally, a good adhesive joint of composite components requires surface preparation of the composite, which can be an extensive and unreliable operation.

Adhesive bonding is thus slow and expensive, requires extensive tooling, and surface preparation is critical. Welding on the other hand is a rapid, inexpensive process that is commonly used with metals and thermoplastic polymer materials. Welding is characterised by the dispersion of the original interface, meaning the strength of the joint is not dependant upon adhesive forces and the joint is much less sensitive to surface contamination.

The present invention alleviates the aforementioned problems in joining composite structures similar to tubes, by providing a method for the accurate fitting together or assembly of composite components. Further, the invention provides a means of welding such fitted together items using a greatly simplified process compared to current joining methods for composite tubes and similar sections.

### SUMMARY OF THE INVENTION

Broadly, the present invention is a method for joining a thermosetting polymer composite component or a thermoplastic polymer composite component to a second component, where the mating surfaces of the components each have at least some points of contact, sufficient to hold the components in their joined state for some time without additional restraint or tooling. The components can be joined together more securely through the application of heat to the joint area, with no external forces required to hold the mating surfaces together during this process. Where the assembled components have mating surfaces consisting of compatible thermoplastic polymers, they can be welded together to make a joint with high joint strength.

A first embodiment of the invention provides a method of fitting a polymer composite to a second component, including the steps of:
selecting a first polymer composite component with a thermoplastic polymer mating surface in at least the joint area;
selecting a second component that, when its joint area is inserted into or around said first component, has a mating surface with at least one point of contact in the joint area with said first component;
shaping, where necessary, the thermoplastic surface in the joint area of said first component or mating surface of the joint area of said second component to provide a neat or interference fit between the two said components when inserted together;
pressing said first component and said second component together in some way such that the mating surfaces of each component become in contact at said points of contact in the joint area, resulting in at least local compressive stress in the thermoplastic surface at the point or points of contact, and relative immobility between the two components:
raising the temperature of the joint area to a temperature where the thermoplastic material in the joint area is able to flow and/or heal;
maintaining said temperature of the joint area for a period to allow flow and/or healing and/or wetting; and
reducing the joint temperature, causing said thermoplastic material to solidify.

In the first embodiment of the invention, the composite component may have a thermosetting or thermoplastic polymer as a major constituent of the composite matrix. In the case where the composite comprises a reinforced thermoplastic polymer, the thermoplastic surface may be the same polymer as the composite matrix. Preferably, the surface thermoplastic is a polymer of lower melt temperature, or lower heat distortion temperature, or higher melt flow index, than the thermoplastic matrix.

A second embodiment of the invention provides a method of fitting a polymer composite component to a second component, by using a third thermoplastic component as an insert, including the steps of:
selecting a first polymer composite component and a second component to be fitted together;
shaping, where necessary, either or both of the mating surface of the joint area of said first and the mating surface of the joint area of the second component to provide a defined gap between the two said components in at least a portion of the joint area;
selecting a third component of thermoplastic material, that has the same sectional geometry on parts of its surface or can be formed to have the same sectional geometry on parts of its surface, as said first and second components, or has the same shape or can be formed into the shape of a portion of the joint area of said first and second components, and that has sufficient thickness to provide a neat or interference fit at least at points of contact in the joint area when assembled with the respective mating surfaces of said first and second components;
pressing said first, second and third components together, such that the surfaces of each component are pressed together at said points of contact in the joint area, resulting in at least local compressive stress in the thermoplastic surface at the points of contact, resulting in relative immobility between the three components:
raising the temperature of the joint area to a temperature where the thermoplastic material in the joint area is able to flow and/or heal;
maintaining said temperature of the joint area for a period to allow flow and/or healing and/or wetting; and
reducing the joint temperature, causing said thermoplastic material to solidify.

In the second embodiment of the invention, the composite may have a thermosetting or thermoplastic polymer as a major constituent of the composite matrix. More preferably, the composite component will have a thermoplastic surface at least in the region of the joint. More preferably, the thermoplastic polymer of the thermoplastic surface is identical to the thermoplastic used for the third component.

Preferably in the first or second embodiment of the invention, the second component to be joined is a polymer composite component. More preferably, the second component has a thermoplastic mating surface in the joint area. In the first embodiment of the invention, the thermoplastic mating surface on the second component is preferably identical to, or at least compatible with, the thermoplastic mating surface on the first component. In the second embodiment of the invention, the thermoplastic mating surface on the second component is preferably identical to the thermoplastic of the third component.

The shape of the joint area in the first and second embodiments of the invention may take many forms. Preferably, considering the movement of the two components in three principal axes, there is sufficient contact between the components in the joint area to constrain relative movement between the assembled components to no more than two degrees of freedom: one translational and one rotational movement, which may be interdependent as in the insertion of a screw thread mating surface. These degrees of freedom allow the components to be fitted to each other, albeit under some required insertion force to overcome any friction between the two components, while all other directions of movement are constrained.

The first and second components in each embodiment may be a closed section, such as a tube, or an open section such as a channel, in the joint area. Said components may also be arranged such that one component has a closed section and the other component an open section in the joint area. Preferably, a joint is made with first and second components that are concentric in the joint area.

The surfacing thermoplastic polymer may be amorphous or semi-crystalline, or have a limited amount of cross-linking such that flow is not impeded above the glass transition temperature or melt temperature of the polymer. The surfacing thermoplastic polymer may also contain a small amount of additional material, such as other polymers, fillers, discrete reinforcing fibres or a lightweight reinforcing fabric.

Preferably, where the composite component has a thermoplastic surface in the joint area, the surface thermoplastic is securely attached to the composite, by chemical or physical means. Physical means of attachment of a thermoplastic to a thermoset or thermoplastic composite may be on a macro scale through roughened surface interlocking or a similar process. More preferably, physical interlocking is created on a molecular level, through interlocking of the thermoset and thermoplastic polymer chains during cure of the thermoset composite component, or through interlocking of respective thermoplastic chains, where there is a discrete thermoplastic surfacing layer on a thermoplastic composite component. One method of providing a thermosetting polymer component with an interpenetrating thermoplastic polymer layer is the subject of International Patent Cooperation Treaty Application No. PCT/AU02/01014, the contents of which are incorporated herein by reference. Chemical means of attachment of a thermoplastic to a thermoset or thermoplastic composite may involve surface treatment of one or more of the components, prior to bringing the thermoplastic surface material in contact with the thermoset or thermoplastic composite.

The thermoplastic surface on the composite component in the first or second embodiment of the invention, and the thermoplastic in the second embodiment of the invention, may have parallel or tapered mating surfaces. Shaping the thermoplastic mating surface on a composite component in the first or second embodiment of the invention, where necessary, may be achieved by machining, or by melting and reshaping the surface with a tool. Advantageously, a composite component with a thermoplastic surface may have the thermoplastic surface reprofiled by means of a static or moving hot tool, shaped to provide the desired surface profile. A method of providing a reprofiled thermoplastic surface on a composite component is the subject of International Patent Cooperation Treaty Application PCT/AU2004/001272, the contents of which are incorporated herein by reference.

Where a thermoplastic surface is present on preferably two components to be joined using either embodiment of the invention, the thermoplastic may be continuous or located discretely on the mating surface. Additionally the thermoplastic surface or surfaces may be shaped so as to provide greater or lesser resistance to the insertion or fitting of the two or three components together, or to provide greater or lesser resistance to the separation of the two or three components once fitted together.

Cooling or heating may optionally be applied to any of the components in either embodiment of the invention to assist in the fitting of components. Advantageously, judicious use of cooling or heating of one or more components may assist in the generation of local compressive stresses in the joint following assembly. More advantageously, the thermoplastic surface on a composite component fitted using the first or second embodiment of the invention may be heated as a part of the process, which may temporarily soften the thermoplastic mating surface or material thereby aiding joint assembly.

Enhancement of joint strength by heating of the joint region, according to either the first or second embodiment of the invention, can be achieved between a first composite component with a thermoplastic surface and a second component in a number of ways. The heat may soften or melt the thermoplastic allowing it to wet the other surface, leading to an adhesive bond between the two. In the instance where the second component has a rough surface, or a multitude of crevices or impressions, the thermoplastic composite surface of the first component may be able to flow into this rough surface, giving the assembled parts after cooling a higher level of attachment through mechanical interlock. Where the second component is also a composite component with a softened or molten thermoplastic surface, the fitting or insertion operation may result in shear flow, squeeze flow and/or healing, resulting in the welding of the two components.

Heating may be provided external to the joint region by means of electric elements, or local provision of heated air or fluid. Alternatively ferromagnetic particles or electrically conductive material may be located in or near the joint region to provide heat for joining of the components.

Preferably, the composite component in either embodiment of the invention will have a thermoplastic mating surface in the joint area. More preferably, the second component will also be a composite component with an attached thermoplastic mating surface in the joint area.

Advantageously, in the first or second embodiments of the invention, where both the first and second components are composite structures having the same thermoplastic mating surface securely attached, the invention provides a means to weld the first and second components together, by melting and later fusing together at least a portion of the contacting thermoplastic mating surfaces. Preferably, the thermoplastic surface material is selected such that heating the thermoplastic surface to cause flow can be achieved below the distortion temperature of any of the assembled components.

Advantageously, where a neat or interference fit is obtained between closed-section or largely closed-section parts of the components in either embodiment of the invention, a weld can be obtained between the components without application of compaction pressure in the region of the joint during welding. Where one or more of the components has a more open section, the invention may be enhanced with the application of some pressure to the joint.

Using the first embodiment of the invention, two composite components with thermoplastic surfaces may be welded together. Advantageously, the surfacing thermoplastics may be dissimilar, and the selection of a thermoplastic-surfaced composite structure in the process of the invention includes the selection of a thermoplastic surface that is compatible in welding with a second thermoplastic on the surface of another component. Similarly, application of the second embodiment of the invention may involve the selection of thermoplastic surfaces on the first or second component, and/or selection of a thermoplastic third component or insert, which is compatible with the other thermoplastic surfaces and/or component in welding. Preferably, in either embodiment of the invention, the thermoplastic surfaces and/or third component will be an identical thermoplastic.

Where, according to either the first or second embodiment of the invention thermoplastic is located discretely on the at least one assembled component, the thermoplastic surfaces may be located and shaped so as to provide carefully-controlled local compression strain in the thermoplastic surfaces once fitted together, or optimum flow in the thermoplastic during the enhancement of joint strength by heating referred to above.

In any of the aspects or embodiments of the invention the thermosetting polymer or thermosetting composite component, or the thermoplastic polymer or thermoplastic polymer component, may include: inserts, foam or honeycomb or other core materials, other thermoplastic polymer subcomponents or films, or any other material that can be incorporated as an integral part of a largely thermosetting polymer or thermosetting polymer composite component, or thermoplastic polymer or thermoplastic polymer composite component.

### BRIEF DESCRIPTION OF THE DRAWINGS

FIG. 1A is a sectional view of a polymer composite tube with a thermoplastic surface, and a flanged collar with a thermoplastic surface, with concentric joining sections;

FIG. 1B is a sectional view of the components depicted in FIG. 1A following assembly;

FIG. 1C is a sectional view of the assembly in FIG. 1B, being heated by an internal hot element;

FIG. 1D is a sectional view of the assembly from FIG. 1C, with components welded together;

FIG. 2A is a sectional view of a polymer composite tube with a thermoplastic surface, a tapered thermoplastic insert and a flanged collar with a thermoplastic surface, each with concentric joining sections;

FIG. 2B is a sectional view of a tapered thermoplastic insert fitted over a polymer composite tube with a thermoplastic surface, and a flanged collar with a thermoplastic surface;

FIG. 2C is a sectional view of a flanged collar with a thermoplastic surface fitted over the assembly from FIG. 2B;

FIG. 2D is a sectional view of the assembly in FIG. 2C, being heated by an internal hot element;

FIG. 2E is a sectional view of the assembly from FIG. 2D, with components welded together;

FIG. 3A shows cross-sections of concentric closed sections with continuous thermoplastic mating surfaces on the inside (left) and outside (right);

FIG. 3B shows cross-sections of concentric open sections with continuous thermoplastic mating surfaces on the inside (left) and outside (right);

FIG. 3C shows cross-sections of concentric open sections with discrete thermoplastic mating surfaces on the inside (left) and outside (right);

FIG. 4A shows discrete surface application of thermoplastic on a composite component, arranged in axial strips;

FIG. 4B shows discrete surface application of thermoplastic on a composite component, arranged in helical strips;

FIG. 4C shows discrete surface application of thermoplastic on a composite component, arranged in dots;

FIG. 5A is a sectional view of a polymer composite tube with a thermoplastic surface, fitted onto a non-composite component with discrete surface depressions, with concentric joining sections;

FIG. 5B is a sectional view of the assembly from FIG. 5A, where the thermoplastic surface of the composite component has filled the surface depressions of the non-composite component.

### DETAILED DESCRIPTION OF THE EMBODIMENTS

In the first embodiment of the invention, one composite component with a thermoplastic surface is selected for fitting together with a second component, to provide a neat or interference fit between the components in the desired joint area. The second component may be constructed from any material. In the case where reshaping of the second component is desired, a surface that can be easily machined or reshaped is desirable. Fitting of metal components, polymer components and polymer composites to the first composite component is preferable using this technique. Where polymers or polymer composites are utilised, a compliant surface is desirable.

One principal reason for the use of or attachment of a thermoplastic surface to the first composite component is the ability of the surface thermoplastic material to undergo at least local compressive strain and deform plastically under fitting operations without rupture. A brittle surface material such as that often found in a thermosetting polymer or a high-temperature thermoplastic polymer may crack and break away. Similarly, either a thermosetting or thermoplastic polymer composite may not have sufficient surface plasticity to undergo a fitting operation using the method of the invention without local failure. Even when the first component being attached is a thermoplastic polymer composite, it may be necessary to have a “resin-rich” surface, or attach a suitable thermoplastic surface. A second reason for selecting a composite component with a thermoplastic surface is its ability to be easily reshaped to meet dimensional tolerance requirements for fitting operations. A third reason for the selection of a composite component with a thermoplastic surface is its ability to be welded, where the surface profile or surface material of the other component allows welding. In this case the thermoplastic surface is ideally able to soften and/or melt at the welding temperature without the matrix resin in the underlying composite softening or melting significantly, allowing the component to retain its shape during the welding operation.

The whole component to be fitted together or welded does not require the concentricity described as being necessary in the joint area in the present invention. For example, plates with welded flanges may be fitted and welded using the method of the invention. Joints between solid and hollow sections may be made with the current process. However the method of the invention is particularly suitable for the joining of one or more tubular products to one or more hubs, end caps, collars, connectors, or other functional components of that nature. The method of the invention is especially suitable for the assembly of space frames, bicycle frames and piping systems.

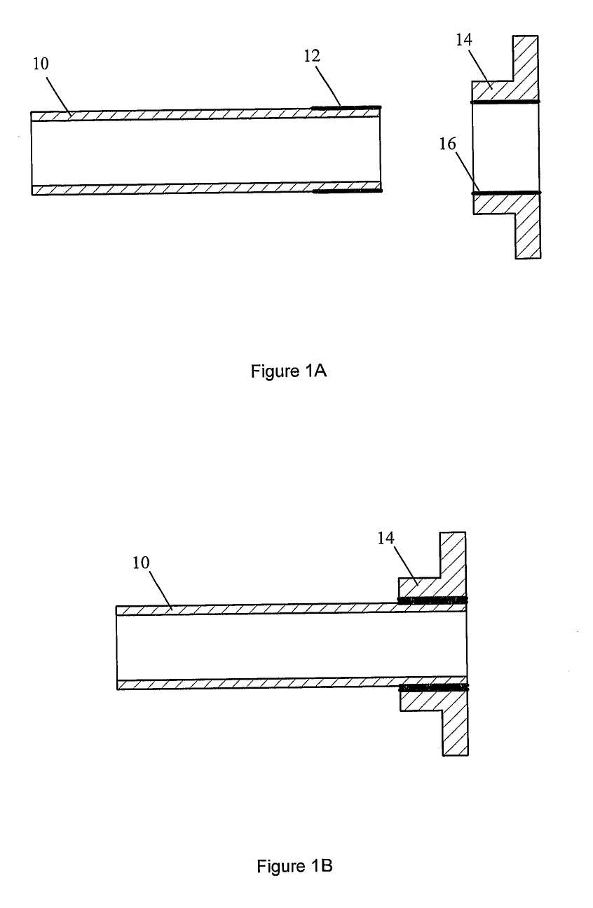

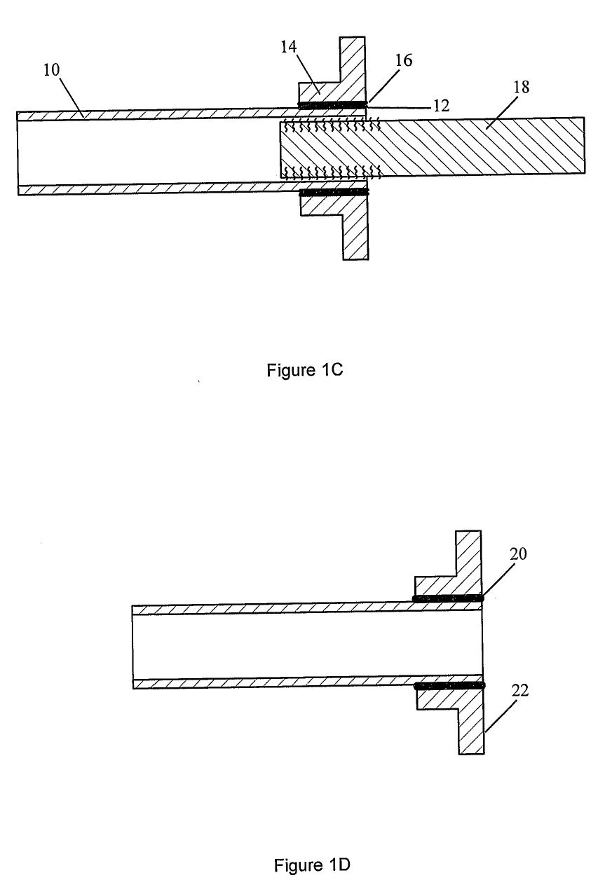

FIG. 1A shows a tube (10) and a flanged collar (14), to be fitted according to the first embodiment of the invention. In the example shown, both of the components are polymer composites with thermoplastic surfaces (12, 16) attached. In the example shown the two components each have only one region which is prepared for assembly to another component. However either of the components may be designed to be assembled with more than one other component in the way described. The preferred method of manufacture of the composite is to use a thermosetting polymer composite and a thermoplastic polymer, where the thermoplastic polymer is selected for its compatibility with the uncured thermosetting polymer. One such example involves carbon-epoxy composite laminates with a strongly attached polyvinylidene fluoride surface: a process for manufacturing such a composite laminate is detailed in PCT/AU02/01014.

Where a largely thermoplastic composite structure is to be used as one component in the intended joint, a polymer identical to, or compatible with, the composite matrix is preferably selected for the thermoplastic surface. One way to manufacture such a component is to collocate the surfacing polymer together with the polymer composite and process under elevated temperature and pressure, allowing the polymer chains of the composite matrix and surfacing thermoplastic to intermingle prior to cooling and removal of pressure.

The surface of the first (12) and/or second (16) component, or at least that part of the component which is to be joined, may be shaped in the next operation. Guidelines for the relative dimensions of parts to be joined by a neat or interference fit may be used for the design of composite components with thermoplastic surfaces, to enable joints of varying tightness and/or required insertion force to be made. Use of the first or second embodiment of the invention, where the components are fixed relative to each other following assembly, relies on the correct choice of relative dimensions between the mating surfaces of the relevant components.

Locally reprofiling the thermoplastic surface of the composite can be achieved using any of the methods described in PCT/AU2004/001272. Tight control of relative dimensions in the joint area will be required to obtain a secure fit, without requiring excessive assembly forces.

FIG. 1B shows the assembled components. The fitting operation may be achieved in a number of ways, dependent on the level of interference of the two thermoplastic surfaces, through force parallel to the central axis of the joint. Hand pressure may be sufficient for some neat-fitted joints, while a press may be required for other scenarios. Where the dimensional tolerances of the thermoplastic mating surface on the composite are correctly specified, the two components in the assembly will be relatively fixed to each other. A sufficient linear force parallel to the axis of the joint, or rotational force around the axis of the joint for circular joint cross sections, may cause relative movement between the components. However movement perpendicular to the joint axis will be constrained.

The assembly operation may also be undertaken following heating or cooling of one or more of the thermoplastic surfaces and/or components shown in FIG. 1A. Heating or cooling may be used to subtly adjust the dimensions of one or more of the components or their mating surfaces. For instance, heating or cooling either component at least locally can be used to cause that component to expand or contract relative to the other component and/or relative to the thermoplastic surface, resulting in an easier assembly operation or more favourable properties in the resulting joint.

Moreover, the thermoplastic surfaces (12, 16) of the two composite components may be raised to a temperature where the thermoplastic is able to flow. Where the thermoplastic surface is attached by a very secure means, such as through an interpenetrating polymer network, the subsequent assembly process can be conducted while maintaining the thermoplastic in a state of flow. The result, where each component has an attached thermoplastic surface, is a welded joint made in one pass. This process may require sufficient compression on the thermoplastic surfaces after assembly that excess thermoplastic can be squeezed away during the fitting process.

FIG. 1C shows the process of welding components together, particularly suited to the joining of two composite components with thermoplastic surfaces. Generally, when the components to be joined are thermoset composite components, care should be taken not to greatly exceed the T_{g} of the thermosetting polymer during heating operations. Likewise for composite components made with a thermoplastic polymer, care should be taken not to approach the T_{g} of an amorphous thermoplastic, or the Tₘ of a semi-crystalline thermoplastic, because of the possibility that the composite component will undergo dimensional change, degrading the properties of the component and/or joint. When choosing a composite component with a thermoplastic surface, the chosen thermoplastic surface is preferentially specified to have a lower melting or softening temperature than the critical temperature of its attached composite matrix.

Applying heat to the joint area may be achieved by one of several methods. Where heat can be applied directly to the thermoplastic, for instance through the use of a resistance element embedded in the thermoplastic surface material, it is feasible to weld components together while the underlying composite structure remains cooler than its critical temperature. When the melt or softening temperature of the surfacing thermoplastic is lower than the critical temperature of the attached composite matrix, it is possible to pass heat to the joint interface through one of the components and thereby effect the weld. Such an example is shown in FIG. 1C, where a hot element (18) is placed inside the joint area, and heat is passed through the inner composite component (10) to the thermoplastic (12, 16). Where a sufficiently tight tolerance is specified for a closed-section joint, the thermoplastic in the joint area will be under compression, and upon melting some mingling and flow of polymer chains will occur, resulting in the unification of the thermoplastic surfaces. Upon cooling the thermoplastic (20) solidifies, resulting in a welded structure (22) as depicted in FIG. 1D.

Heating the thermoplastic polymer layers at the site of the joint would not only aid the joining of the two components, but may also provide for the possibility of disassembly, repair, relocation or realigning of the components. By heating the thermoplastic polymer interface between two previously joined components, the components could be removed from one another to aid disassembly of the structure. One or more of the components could then be replaced with another component, or the thermoplastic interface could be repaired (possibly through addition of further thermoplastic polymer material) or the two components could be moved relative to each other to a new relative position.

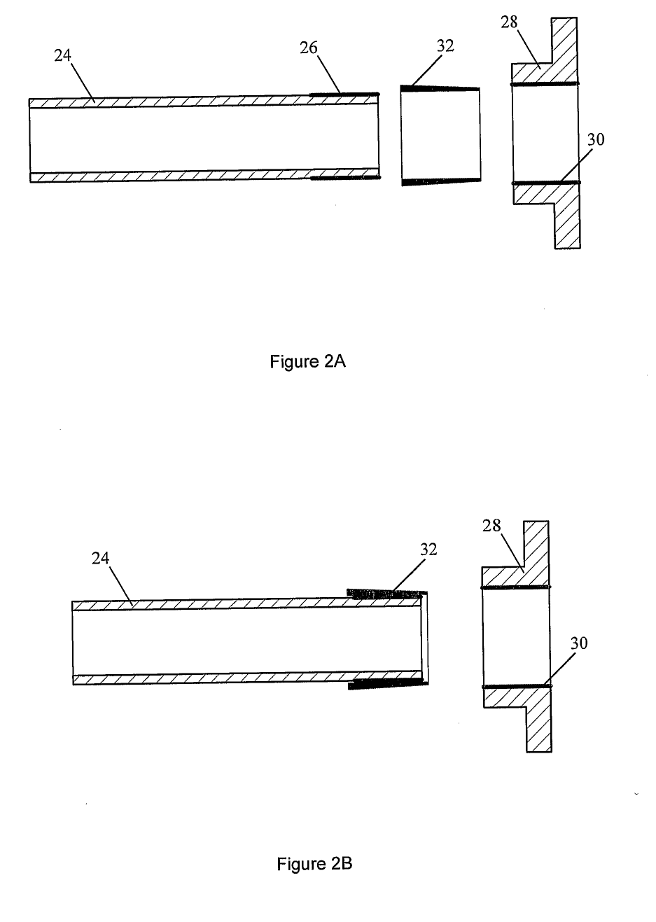

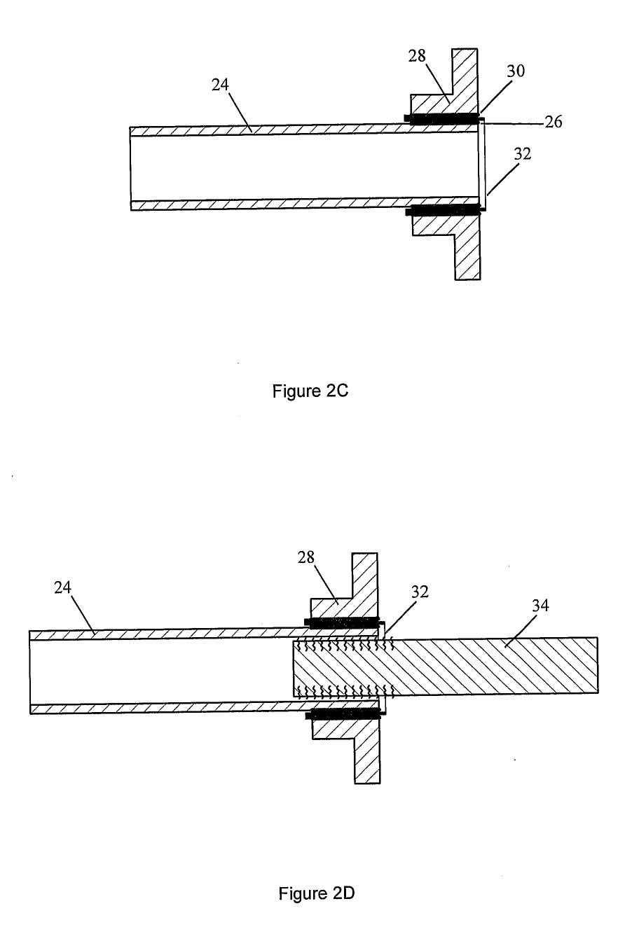

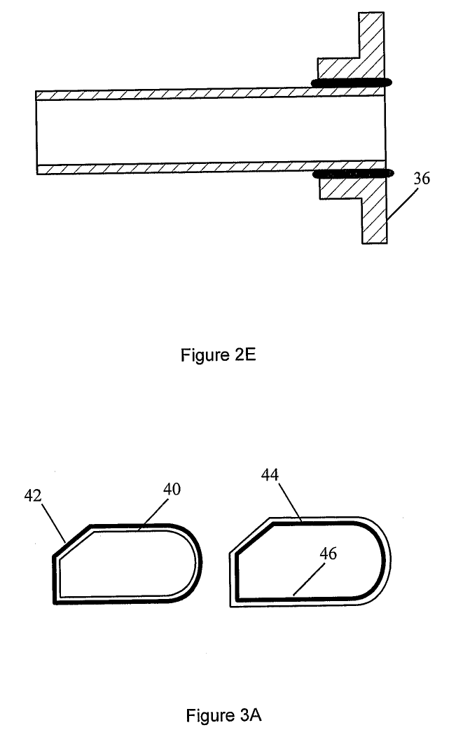

FIG. 2A shows a tube (24), thermoplastic insert (32) and a flanged collar (28), to be assembled according to the second embodiment of the invention. Both the tube (24) and flanged collar (28) in the example shown consist of a composite material with a thermoplastic mating surface (26, 30). The assembly or fitting process of the three components can occur in a variety of different ways. FIG. 2B depicts the operation of fitting the thermoplastic insert (32) to the composite tube (24) in the joint region. However, the insert (32) could also be sandwiched between the first (24) and second (28) component, with the application of assembly force resulting in the collocation of both components (24, 28) with the insert (32) in the joint. The possible advantage of the operation depicted in FIG. 2B is the potential use of a carefully-shaped and engineered thermoplastic third component insert (32). While the thermoplastic surface (26) of the inner component (24) could be shaped such as to a taper, it may be more convenient to separately manufacture a shaped third component. FIG. 2C shows the assembled components (24, 28) and insert (32). The assembly operation in this instance may be, to a degree, self-aligning, due to the use of a taper in the thermoplastic insert (32). Through use of an insert (32), there is also likely to be excess thermoplastic material on either side of the joint.

The insert may be made of one thermoplastic material or several thermoplastic materials fused or otherwise joined together, and have different materials on parts of its surfaces so that a suitable joint can be made with both the other two components. In addition the insert may be made at least partly of a material which expands, contracts or changes shape during assembly of the joint or in subsequent heating. One example of this would is an insert made at least partially of a “heat shrink” or “shape memory” polymer or other material, which is designed to attempt to return to a different shape during heating. This action could ensure excellent filling of the gap between the joint surfaces of the male and female components, and/or improved flow into any surface roughness or cavities in the mating surfaces of those components, and/or improved local contact pressure to aid welding of the insert to the first or second components. In a preferred embodiment, the “heat shrink” material would be able to be at least partially welded to the polymer surface of the first or second components through diffusion of that polymer into the heat shrink material under elevated temperature.

FIG. 2D depicts the process of raising the temperature of the thermoplastic material to improve joint quality, in the same manner as described for the first embodiment of the invention i.e. by use of a hot element (34). Where compatible thermoplastic insert (30) and thermoplastic surfaces (26, 30) on the composite components (24, 28) depicted in FIG. 2D are selected, flow and healing of the thermoplastic in the joint area can occur, and following cooling of the joint a welded assembly (36) can be obtained, as shown in FIG. 2E.

A requirement for successful application of either embodiment of the invention to joining of a composite component is a constant or near-constant cross-section in the joint area. An example of a joint with a near-constant cross section that may be joined successfully using either embodiment of the invention is a tubular component with one or more tapered regions in the joint area.

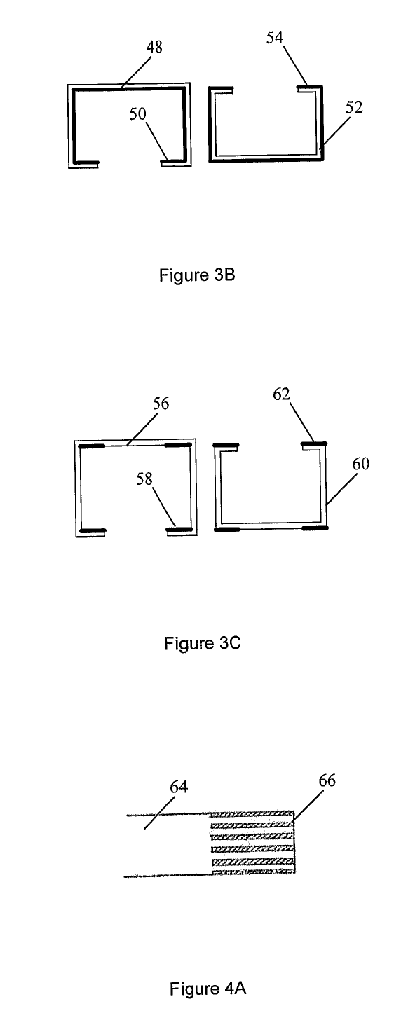

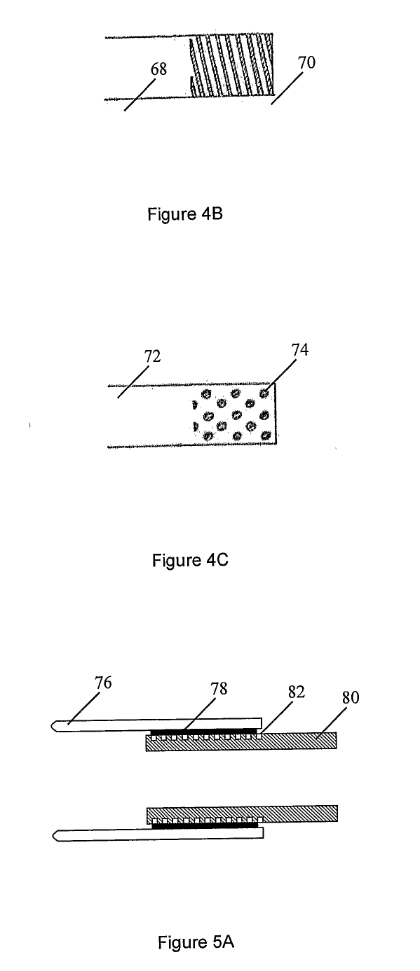

Examples of closed- and open-section cross-sectional geometries that can be used with the first embodiment of the invention are shown in FIG. 3A, which shows the geometry for fitting and subsequent welding of two composite components (40, 44) with thermoplastic surfaces (42, 46) according to the first embodiment of the invention. In this instance, the joint cross-sections are concentric and closed, with one component (40) having mating thermoplastic outer surface (42), with the other component (44) having mating thermoplastic inner surface (46). An example of open cross-section components (48, 52) is shown in FIG. 3B. In this case the components (48, 52) are also established for fitting and welding according to the first embodiment of the invention. Close tolerance fitting using this joint geometry may result in less accurate fitting placement of the two components than a closed-section joint, as well as regions of low welding pressure. However the joint may be suitable for some types of component assembly or welding. The open cross-sections (48, 52) also have continuous thermoplastic surfaces (50, 54) in this example in the joint region. A further variation is shown in FIG. 3C, where thermoplastic surfaces (58, 62) are located discretely around the components (56, 60). This configuration may be particularly useful where low assembly pressures are required, and tack or spot welding is sufficient for the required joint performance. Discrete application of thermoplastic material can also be applied to closed-section components so as to provide controlled local strain after assembly with a female component, and controlled polymer flow during subsequent heating. Examples of tubes (64, 68, 72) with thermoplastic material located discretely on its joint surface are shown in FIG. 4 in the form of a spline-shaped thermoplastic surface 66 (FIG. 4a), a helical screw thermoplastic surface (70) (FIG. 4b), and discrete thermoplastic dots (74) (FIG. 4c).

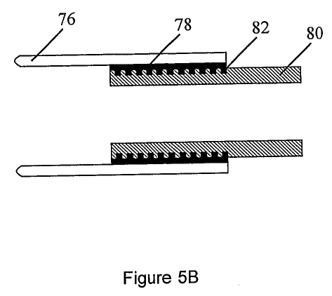

Use of heating in the first embodiment of the invention will particularly aid the joining of composite components to non-composite components. FIG. 5a depicts the joining of a composite component (76) with a thermoplastic surface (78) to a non-composite component (80), for example a metal component. This component (80) has a surface containing discrete grooves (82), but could likewise have a roughened surface or a surface with a continuous groove such as a screw thread. Upon assembling the components, the non-composite component (80) will have depressions (82) that are not filled with the surface thermoplastic polymer (78) from the composite component (76). Upon applying heat to the joint region thermoplastic (78) will flow into these depressions (82), as indicated in FIG. 5b, and upon cooling solidify to prevent easy disassembly of the two components.

### EXPERIMENTAL DISCUSSION

Concentric tube specimens of approximately 1.7 mm wall thickness were manufactured from carbon epoxy prepreg, consisting of four plies of CYCOM 970/PWC T300 3K ST plain weave fabric prepreg and four plies of CYCOM 970/T300 12K NT unidirectional tape prepreg, in a symmetric layup. The outer diameter of the male tube was approximately 30 mm. A layer of PVDF thermoplastic was placed on the tubes' joining surfaces (0.076 mm and 0.254 mm on the female and male tubes, respectively), and the tubes were cured at 177° C. at 650 kPa for 2 hours in a female tool. The resulting difference in diameters between the tubes was −0.088 mm i.e. the outer diameter of the male tube was 0.088 mm larger than the inner diameter of the female tube. The tubes were assembled by cold press, with a resulting joint length of 25 mm. The tubes assembled by this method could not be moved relative to one another by hand. The assembly was then heated to 185° C. in the joint region and maintained at that temperature for 10 minutes, with subsequent cooling. The result was that the composite tubes were welded together. Compression testing of the tubes (loading of the welded region in shear) resulted in compression failure of the male tube, i.e no failure of the joint was recorded, at a load of 46 kN.

It will be understood that the invention disclosed and defined in this specification extends to all alternative combinations of two or more of the individual features mentioned or evident from the text or drawings. All of these different combinations constitute various alternative aspects of the invention.

It will also be understood that the term “comprises” (or its grammatical variants) as used in this specification is equivalent to the term “includes” and should not be taken as excluding the presence of other elements or features.

1. A method of fitting a composite component to a second component, including the steps of:
selecting a first polymer composite component with a thermoplastic polymer mating surface in at least the joint area;
selecting a second component that, when its joint area is inserted into or around said first component, has a mating surface with at least one point of contact in the joint area with said first component;
shaping, where necessary, the thermoplastic surface in the joint area of said first component or mating surface of the joint area of said second component to provide a neat or interference fit between the two said components when inserted together;
pressing said first component and said second component together such that the mating surfaces of each component become in contact at said point or points of contact in the joint area, resulting in at least local compressive stress in the thermoplastic surface at the point or points of contact, and relative immobility between the two components:
raising the temperature of the joint area to a temperature where the thermoplastic material in the joint area is able to flow and/or heal;
maintaining said temperature of the joint area for a period to allow flow and/or healing and/or wetting; and
reducing the joint temperature, causing said thermoplastic material to solidify.

2. The method according to claim 1 where said polymer composite component comprises of a reinforced thermosetting polymer.

3. The method according to claim 1 where said polymer composite component comprises of a reinforced thermoplastic polymer.

4. The method according to claim 3 where the surface thermoplastic material is a polymer of lower melt temperature, or lower heat distortion temperature, or higher melt flow index, than the thermoplastic matrix of said polymer composite component.

5. A method of fitting a polymer composite component to a second component, by using a third thermoplastic component as an insert, including the steps of:
selecting a first polymer composite component with a thermoplastic surface in at least the region of the joint, and a second component to be fitted together;
shaping, where necessary, the mating surface of the joint area of either or both of said first and the second component to provide a defined gap between the two said components in at least a portion of the joint area;
selecting a third component of thermoplastic material, that has the same sectional geometry on parts of its surface or can be formed to have the same sectional geometry on parts of its surface, as said first and second components, or has the same shape or can be formed into the shape of a portion of the joint area of said first and second components, and that has sufficient thickness to provide a neat or interference fit at least at points of contact in the joint area when assembled with the respective mating surfaces of said first and second components;
pressing said first, second and third components together, such that the surfaces of each component are pressed together at said points of contact in the joint area, resulting in at least local compressive stress in the thermoplastic surface at the points of contact, resulting in relative immobility between the three components:
raising the temperature of the joint area to a temperature where the thermoplastic material in the joint area is able to flow and/or heal;
maintaining said temperature of the joint area for a period to allow flow and/or healing and/or wetting; and
reducing the joint temperature, causing said thermoplastic material to solidify.

6. The method according to claim 5 where said polymer composite component comprises of a reinforced thermoset polymer.

7. The method according to claim 5 where said polymer composite component comprises of a reinforced thermoplastic polymer.

8. The method according to claim 7 where the surface thermoplastic is a polymer of lower melt temperature, or lower heat distortion temperature, or higher melt flow index, than the thermoplastic matrix of said polymer composite component.

9. The method according to claim 5 where the third component consists of a thermoplastic material identical to the surfacing thermoplastic material of the first component.

10. The method according to claim 5 where the second component is a polymer composite component with a thermoplastic surface in at least the region of the joint.

11. The method according to claim 10 where the surfacing thermoplastic polymer of the second component is compatible in welding with the surfacing thermoplastic polymer of the first component and/or the thermoplastic polymer of the third component.

12. The method according to claim 10 where, when assembled, the first and second component are constrained to one rotational and one translational direction of relative movement.

13. The method according to claim 10 where the first and second components are concentric in the joint area.

14. The method according to claim 10 where the surfacing thermoplastic polymer is amorphous, semi-crystalline, or having a limited amount of cross-linking such that flow is not impeded above the glass transition temperature or melt temperature of the polymer.

15. The method according to claim 5 where the surfacing thermoplastic material consists of a thermoplastic polymer with at least one additive selected from the group of an additional polymer, filler, discrete reinforcing fibres and a lightweight reinforcing fabric.

16. The method according to claim 10 where the thermoplastic surface is attached to the underlying polymer composite by physical interlocking.

17. The method according to claim 10 where the thermoplastic surface on the first or second polymer composite component is attached through molecular level interpenetration of the surfacing thermoplastic and the underlying polymer.

18. The method of claim 17 where the surfacing thermoplastic is PVDF and the underlying polymer composite component consists of carbon fibre and epoxy.

19. The method according to claim 5 where the thermoplastic surface or surfaces are shaped prior to assembly by machining or melt reshaping with an appropriate tool.

20. The method according to claim 19 where the thermoplastic surface of at least one component is tapered with respect to the second component in the joint assembly region.

21. The method according to claim 15 where heating or cooling of at least one component is used to aid the assembly of the components.

22. The method according to claim 5 where the thermoplastic is heated by means of ferromagnetic particles or electrically conductive material in or near the joint region.

23. The method according to claim 5 where the thermoplastic in the joint region flows into crevices or impressions in the surface of the second component.

24. The method according to claim 5 where the surfacing thermoplastic material is selected such that heating the thermoplastic surface to cause flow can be achieved below the distortion temperature of any of the assembled components.

25. The method according to claim 10 where a weld is obtained between the first and second components without the application of external pressure.

26. The method according to claim 25 where the surfacing thermoplastic polymer of the first and second components is identical.

27. The method according to claim 5 where the thermoplastic material on the mating surface of the first or second component is discontinuous in the joint region.

28. An assembly of a first polymer composite component joined to a second component, wherein the assembly is formed according to the method of claim 5.

29. The method according to claim 1 where the second component is a polymer composite component with a thermoplastic surface in at least the region of the joint.

30. The method according to claim 5 where the surfacing thermoplastic polymer of the second component is compatible in welding with the surfacing thermoplastic polymer of the first component and/or the thermoplastic polymer of the third component.

31. The method according to claim 5 where, when assembled, the first and second component are constrained to one rotational and one translational direction of relative movement.

32. The method according to claim 5 where the first and second components are concentric in the joint area.

33. The method according to claim 5 where the surfacing thermoplastic polymer is amorphous, semi-crystalline, or having a limited amount of cross-linking such that flow is not impeded above the glass transition temperature or melt temperature of the polymer.

34. The method according to claim 1 where the surfacing thermoplastic material consists of a thermoplastic polymer with at least one additive selected from the group of an additional polymer, filler, discrete reinforcing fibres and a lightweight reinforcing fabric.

35. The method according to claim 5 where the thermoplastic surface is attached to the underlying polymer composite by physical interlocking.

36. The method according to claim 5 where the thermoplastic surface on the first or second polymer composite component is attached through molecular level interpenetration of the surfacing thermoplastic and the underlying polymer.

37. The method of claim 12 where the surfacing thermoplastic is PVDF and the underlying polymer composite component consists of carbon fibre and epoxy.

38. The method according to claim 1 where the thermoplastic surface or surfaces are shaped prior to assembly by machining or melt reshaping with an appropriate tool.

39. The method according to claim 14 where the thermoplastic surface of at least one component is tapered with respect to the second component in the joint assembly region.

40. The method according to claim 1 where heating or cooling of at least one component is used to aid the assembly of the components.

41. The method according to claim 1 where the thermoplastic is heated by means of ferromagnetic particles or electrically conductive material in or near the joint region.

42. The method according to claim 1 where the thermoplastic in the joint region flows into crevices or impressions in the surface of the second component.

43. The method according to claim 1 where the surfacing thermoplastic material is selected such that heating the thermoplastic surface to cause flow can be achieved below the distortion temperature of any of the assembled components.

44. The method according to claim 5 where a weld is obtained between the first and second components without the application of external pressure.

45. The method according to claim 20 where the surfacing thermoplastic polymer of the first and second components is identical.

46. The method according to claim 1 where the thermoplastic material on the mating surface of the first or second component is discontinuous in the joint region.

47. An assembly of a first polymer composite component joined to a second component, wherein the assembly is formed according to the method of claim 1.
